(19) United States
(12) Patent Application Publication
(10) Pub. No.: US 2015/0315497 A1
(43) Pub. Date: Nov. 5, 2015

(54) SYSTEMS AND METHODS OF INTEGRATED SEPARATION AND CONVERSION OF HYDROTREATED HEAVY OIL

(71) Applicants: Patrick Loring HANKS, Bridgewater, NJ (US); William Ernest LEWIS, Baton Rouge, LA (US)

(72) Inventors: Patrick Loring HANKS, Bridgewater, NJ (US); William Ernest LEWIS, Baton Rouge, LA (US)

(73) Assignee: ExxonMobil Research and Engineering Company, Annandale, NJ (US)

(21) Appl. No.: 14/692,247

(22) Filed: Apr. 21, 2015

Related U.S. Application Data
(60) Provisional application No. 61/986,925, filed on May 1, 2014.

(51) Int. Cl. C10G 69/06; B01J 19/24

(52) U.S. Cl. CPC C10G 69/06; B01J 19/24; B01J 19/245; B01J 2219/24

(57) ABSTRACT

Systems and methods are providing for integrating a cavitation unit to the backend separation system of a hydrotreater to improve conversion,

### CROSS-REFERENCE TO RELATED APPLICATION

The present application claims priority to U.S. Patent Application Ser. No. 61/986,925, filed May 1, 2014.

### FIELD

The present invention relates to the separation and conversion of hydrotreated heavy oil. More specifically, the present invention relates to systems and methods of utilizing hydrodynamic cavitation to convert hydrocarbon molecules in backend separation systems of heavy oil hydrotreaters.

### BACKGROUND

Heavy vacuum gas oils and residua are often treated to remove or reduce sulfur, nitrogen and metals before the oils are further converted into more valuable products. Hydrotreatment is a process that is often employed upstream of a fluidized cat cracker (“FCC”) to remove such components from the oil and can also reduce Conradson carbon residue, saturate aromatics, and improve FCC conversion and selectivities.

Despite such processing capabilities, there remains a need for process improvements that improve the efficiency of conversion and separation of valuable hydrocarbon products from such heavy vacuum gas oils.

### SUMMARY

The present invention addresses these and other problems by providing systems and methods for integrating a cavitation unit to the backend separation system of a hydrotreater.

In one aspect, a method is provided for converting a hydrotreated heavy oil. The method includes separating a stream of hydrotreated heavy oil into a vapor phase and a liquid phase, and feeding at least a portion of the liquid phase to a cavitation unit wherein the portion of the liquid phase is subjected to cavitation to convert a portion of hydrocarbons in the portion of the liquid phase to lower molecular weight hydrocarbons in a cavitated stream.

In another aspect, a system is provided for converting a hydrotreated heavy oil. The system includes a separation unit for separating a. stream of hydrotreated heavy oil into a vapor phase and a liquid phase; and a cavitation unit downstream of the separation unit, wherein the cavitation unit receives at least a portion of the liquid phase of the hydrotreated heavy oil and subjects the portion of the liquid phase to cavitation to convert at least a portion of the hydrocarbon molecules present in the portion of the liquid phase into lower molecular weight hydrocarbons.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a system for separation and conversion of hydrotreated heavy oil, according to one or more embodiments of the present invention.

### DETAILED DESCRIPTION

As used herein, the term “heavy oil” refers to hydrocarbon oils having a high viscosity or an API gravity of 23 or less. One way of defining a feedstock is based on the boiling range of the feed. One option for defining a boiling range is to use an initial boiling point for a feed and/or a final boiling point for a feed. Another option, which in some instances may provide a more representative description of a feed, is to characterize a feed based on the amount of the feed that boils at one or more temperatures. For example, a “T5” boiling point for a feed is defined as the temperature at which 5 wt % of the feed will boil off at atmospheric pressure. Similarly, a “T95” boiling point is a temperature at 95 wt % of the feed will boil at atmospheric pressure.

Suitable feeds include, but are not limited to, atmospheric resid with a T5 at about 650° F. or greater, vacuum gas oil (VGO) with a T5 of about 650° F. or greater, and vacuum resid with a T5 above about 800° F., and combinations thereof. Furthermore, the term “pitch” is understood to refer vacuum resid, or material having an initial boiling point of greater than about 950° F. Suitable feeds include an API gravity of no more than 23, typically no more than 10 and may include feeds with an API of less than 5. In any embodiment, the heavy oil may have a T95 (the temperature at which most all the material has boiled off, leaving only 5% remaining in the distillation pot) of 900° F. or more, or 1000° F. or more.

Advantageously, the systems and methods of the present invention may take advantage of the thermal condition and composition of hydrocarbon streams in the backend separation section of hydrotreaters to economically convert less valuable hydrocarbon products to higher value hydrocarbon products. For example, in some embodiments additional hydrocarbon conversion may be achieved without requiring added heat exchanger units or capacity and/or pumps. Furthermore, such conversion may be achieved utilizing cavitation equipment that impose low capital and operating costs and require little physical plant space.

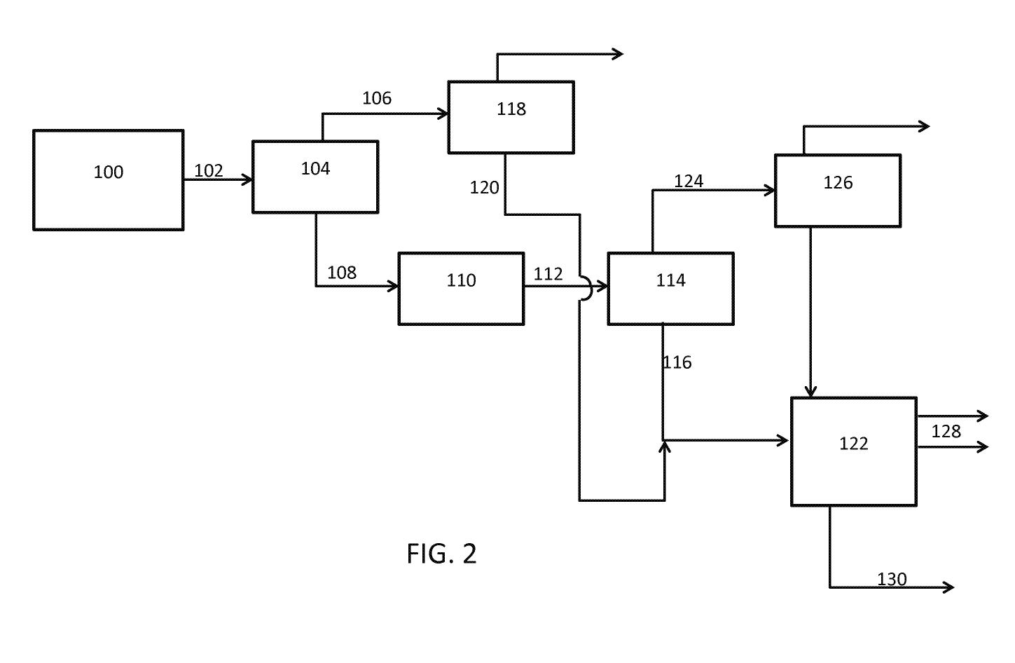

In an exemplary embodiment, as illustrated in FIG. 2, a hydrotreated heavy oil feed stream 102 is fed to a first separating unit 104 from the hydrotreater unit 100. The hydrotreater unit 100 may be one or more reactors suitable for adding hydrogen to a petroleum fraction, such as a heavy oil, to remove sulfur, nitrogen, and metals. The hydrotreater unit 100 may, for example, may be a fixed bed reactor using either cobalt-molybdenum or nickel-molybdenum catalyst. The hydrotreater unit 100 may also be a slurry or fluid bed process using molybdenum-based or platinum-based catalysts. In any embodiment, the hydrotreater unit 100 may be a cat feed hydrotreater (“CFHT”), which treats the VGO stream prior to the stream being fed to the fluid catalytic cracking unit. In any such embodiment, the CFHT may operate between 800 and 2500 psig. In any embodiment, the hydrotreater unit 100 may also be a resid hydrotreator, which is used to treat atmospheric resid or vacuum resid. In such an embodiment, the resid hydrotreator may operate at a pressure greater than 1500 psig, such as around 2800 psig. In any embodiment, the hydrotreated heavy oil feed stream 102 may have a lower sulfur content, lower nitrogen content, lower metal content, lower Conradson carbon residue (CCR) content, or a combination thereof than the heavy oil stream that is fed to the hydrotreater unit 100.

The first separating unit 104 may be operated at a pressure and temperature to recover a portion of hydrogen and light fraction (indicated by stream 106) from the hydrotreated heavy oil feed stream 102. In any embodiment, the first separating unit 104 may operate at a temperature of about 550 to 740° F., or more preferably 700 to 720° F. and a pressure of about 14 to 17 MPa or more preferably 15 to 16 MPa.

The vapor stream 106 from the first separating unit 104 may be fed to a subsequent separating unit 118 (which may include one or more separating devices, e.g., separating devices arranged in series) to recover hydrogen gas. The separating unit 118 may operate at a temperature of about 440 to 550° F., or more preferably 460 to 500° F., and at a pressure of greater than 400 psig, or greater than 1000 psig, or greater than 2000 psig.

The liquid fraction from the first separating unit 104 is fed as a liquid stream 108 to a hydrodynamic cavitation unit 110 where the stream is subjected to hydrodynamic cavitation to produce a converted stream 112. Aspects and operation of the hydrodynamic cavitation unit 110 are described in greater detail subsequently herein. When subjected to hydrodynamic cavitation, a portion of the liquid feed 108 is converted to lower molecular weight hydrocarbons. For example, the hydrodynamic cavitation unit 110 may convert between 1 to 50 wt % of the 1050+° F. boiling range material in the liquid feed, between 1 to 35 wt % of the 1050+° F. boiling range material in the liquid feed, or between 5 and 35 wt % of the 1050+° F. boiling range material in the liquid feed.

Advantageously, liquid stream 108, having been hydrotreated, may be saturated with dissolved hydrogen, which facilitates bubble formation and radical capping of the hydrocarbon molecules during cavitation. Also, the liquid stream 108, having just left the first separating unit 104, is already at a temperature and pressure suitable for hydrodynamic cavitation. For example, the liquid stream 108 may be at a temperature of at least 700° F. (371° C.) and a pressure of at least 15 MPa. In such a case, additional pumps or heat exchangers may not be required between the separating unit 104 and the cavitation unit 110, thereby enabling additional conversion of heavier hydrocarbon molecules to more valuable lighter hydrocarbon molecules without incurring additional capital and operating expenses associated with additional pumps or heat exchangers.

The converted stream 112 may then be fed to a post-cavitation separating unit 114, where the converted stream 112 is further separated into liquid and vapor fractions. The vapor fraction, which may contain additional hydrogen and light fractions may leave the post-cavitation separating unit 114 as a vapor stream 124 for subsequent separations and/or to an amine treatment unit 126 for removal of sulfur (e.g., in the form of H₂S) from the vapor stream 124.

The liquid fraction leaves post-cavitation separating unit 114 as a liquid stream 116 and may be mixed with the liquid stream 120 before being fed to the fractionation unit 122, where a. plurality of products 128, such as naphtha and distillate are separated from vacuum gasoil and resid range material 130.

### Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than most of the mass in the vapor bubble can transfer to the surrounding liquid, resulting in a near adiabatic collapse. This generates extremely high localized energy densities (temperature, pressure) capable of dealkylation of side chains from large hydrocarbon molecules, creating free radicals and other sonochemical reactions.

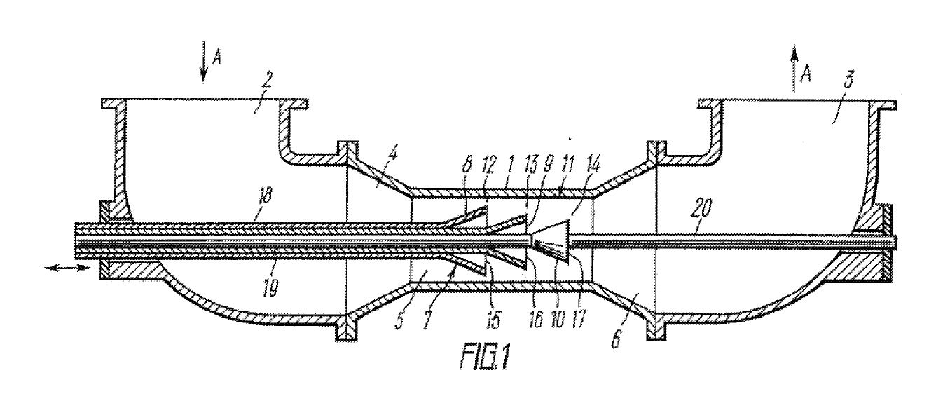

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing I having inlet opening 2 and outlet opening 3, and internally accommodating a contractor 4, a flow channel 5 and a diffuser 6 which are arranged in succession on the side of the opening 2 and are connected. with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 which exceeds the diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms (not shown in FIG. for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9; however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,492,654, which is incorporated by reference herein in its entirety. Other designs of hydrodynamic cavitation units are described in the published literature, including but not limited to U.S. Pat. Nos. 5,937,906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may he accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and bubbles. In the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapsing of the cavitation bubbles. For example, the bubble collapse time duration may be on the magnitude of 10⁻⁶ to 10⁻⁸ second. The precise duration of the collapse is dependent upon the size of the bubbles and the static pressure of the flow. The flow velocities reached during the collapse of the vacuum may be 100-1000 times faster than the first velocity or 6-100 times faster than the second velocity. In this final stage of bubble collapse, the elevated temperatures in the bubbles are realized with a rate of change of 10¹⁰-10¹² K/sec. The vaporous/gaseous mixture of hydrocarbons found inside the bubbles may to reach temperatures in the range of 1500-15,000K at a pressure of 100-1500 MPa. Under these physical conditions inside of the cavitation bubbles, thermal cracking or decomposition of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (ie, thermal cracking of hydrocarbons and dealkylation of side chains) occurs. The rapid velocities achieved during the implosion generate a shockwave that can: mechanically disrupt agglomerates (such as asphaltene agglomerates or agglomerated particulates), create emulsions with small mean droplet diameters, and reduce mean particulate size in a slurry.

### Specific Embodiment

To better illustrate aspects of the present invention, the following specific embodiments are provided:

Paragraph A—A method for converting a hydrotreated heavy oil comprising: separating a stream of hydrotreated heavy oil into a vapor phase and a liquid phase, and feeding at least a portion of the liquid phase to a cavitation unit wherein the portion of the liquid phase is subjected to cavitation to convert a portion of hydrocarbons in the portion of the liquid phase to lower molecular weight hydrocarbons in a cavitated stream.

Paragraph B—The method of Paragraph A, wherein the hydrotreated heavy oil has a T95 of 900° F. or higher.

Paragraph C—The method of Paragraph A or B, wherein the step of separating the stream of hydrotreated heavy oil is performed in a single stage flash vessel.

Paragraph D—The method of any of Paragraphs A-C, wherein the step of separating the hydrotreated heavy oil is performed after hydrotreating the heavy oil without passing the hydrotreated heavy oil through an intervening heat exchanger.

Paragraph E—The method of any of Paragraphs A-D, wherein the cavitation unit is a hydrodynamic cavitation unit adapted to subject the portion of the liquid phase to hydrodynamic cavitation.

Paragraph F—The method of any of Paragraphs A-E, wherein the hydrodynamic cavitation unit subjects the portion of the liquid phase to a pressure drop of at least 400 psig, or greater than 1000 psig, or greater than 2000 psig.

Paragraph G—The method of any of Paragraphs A-F, wherein the portion of the liquid phase is fed to the hydrodynamic cavitation unit at a temperature of at least 450° F.

Paragraph H—The method of any of Paragraphs A-G, wherein the portion of the liquid phase comprises a 1050+° F. boiling point fraction, and wherein the cavitation converts 1 to 50 wt % of the 1050+° F. boiling point fraction to lower molecular weight hydrocarbons.

The method of any of Paragraphs A-H, wherein the step of separating is performed at a temperature of 700° F. or greater.

Paragraph J—The method of any of Paragraphs A-I, wherein the cavitation is performed in the absence of a catalyst.

Paragraph K—The method of any of Paragraphs A-J, wherein the cavitation is performed in the absence of a diluent oil.

Paragraph L—The method of any of Paragraphs A-K, wherein the cavitation is performed in the absence of steam or water,

Paragraph M—The method of any of Paragraphs A-L, further comprising upgrading the cavitated stream by distillation, extraction, hydrofinishing, hydrocracking, fluidized cat cracking, dewaxing, delayed coking, fluid coking, partial oxidation, gasification, deasphalting, fuel oil blending, or a combination thereof.

Paragraph N—A system adapted to perform the method of any of Paragraphs A-M.

Paragraph 0—A system for converting a hydrotreated heavy oil is comprising: a separation unit for separating a stream of hydrotreated heavy oil into a vapor phase and a liquid phase; a cavitation unit downstream of the separation unit, wherein the cavitation unit receives at least a portion of the liquid phase of the hydrotreated heavy oil and subjects the portion of the liquid phase to cavitation to convert at least a portion of the hydrocarbon molecules present in the portion of the liquid phase into lower molecular weight hydrocarbons.

Paragraph P—The system of Paragraph N or O, wherein the cavitation unit is a hydrodynamic cavitation unit.

Paragraph Q—The system of any of Paragraphs N-P, wherein the separation unit is a single stage flash vessel.

Paragraph R—The system of any of Paragraphs N-Q, further comprising the stream of hydrotreated heavy oil, and wherein the hydrotreated heavy oil has a T95 of 900° F. or higher.

Paragraph S—The system of any of Paragraphs N-R, further comprising a hydrotreater.

Paragraph T—The system of any of Paragraphs N-S, wherein the system is devoid of a heat exchanger between the hydrotreater and the separation unit.

Paragraph U—The method or system of any of Paragraphs A-T, wherein the feed to the cavitation unit is in the absence of a separate hydrogen gas containing vapor phase.

What is claimed is:

1. A method for converting a heavy oil comprising:
at least partially hydrotreating a hydrocarbon-containing stream having an API of no greater than 23° and a T5 of at least 650° F. to produce a hydrotreated heavy oil stream;
separating the hydrotreated heavy oil stream into a vapor phase and a liquid phase, and
feeding at least a portion of the liquid phase to a cavitation unit wherein the portion of the liquid phase is subjected to cavitation to convert a portion Of hydrocarbons in the portion of the liquid phase to lower molecular weight hydrocarbons in a cavitated stream.

2. The method of claim 1, wherein the hydrocarbon-containing stream has a T95 of 900° F. or higher.

3. The method of claim 1, wherein the step of separating the hydrotreated heavy oil stream is performed in a single stage flash vessel.

4. The method of claim 1, wherein the step of separating the hydrotreated heavy oil stream is performed after hydrotreating the heavy oil without passing the hydrotreated heavy oil stream through an intervening heat exchanger.

5. The method of claim 1, wherein the cavitation unit is a hydrodynamic cavitation unit adapted to subject the portion of the liquid phase to hydrodynamic cavitation.

6. The method of claim 5, wherein the hydrodynamic cavitation unit subjects the portion of the liquid phase to a pressure drop of at least 400 psig.

7. The method of claim 6, wherein the pressure drop is greater than 1000 psig.

8. The method of claim 7, wherein the pressure drop is greater than 2000 psig.

9. The method of claim 5, wherein the portion of the liquid phase is fed to the hydrodynamic cavitation unit at a temperature of at least 450° F.

10. The method of claim 1, wherein the portion of the liquid phase comprises a 1050+° F. boiling point fraction, and wherein the cavitation converts 1 to 50 wt % of the 1050+° F. boiling point fraction to lower molecular weight hydrocarbons.

11. The method of claim 1, wherein the step of separating is performed at a temperature of 450° F. or greater.

12. The method of claim 1, wherein the cavitation is performed in the absence of a catalyst.

13. The method of claim 1, wherein the cavitation is performed in the absence of a diluent oil.

14. The method of claim 1, wherein the cavitation is performed in the absence of steam or water.

15. The method of claim 1, wherein the feed to the cavitation unit is devoid of a hydrogen gas containing vapor phase.

16. The method of claim 1, further comprising upgrading the cavitated stream by distillation, extraction, hydrofinishing, hydrocracking, fluidized cat cracking, dewaxing, delayed coking, fluid coking, partial oxidation, gasification, deasphalting, fuel oil blending, or a combination thereof.

17. A system for converting a hydrotreated heavy oil comprising:
a separation unit for separating a stream of hydrotreated heavy oil into a vapor phase and a liquid phase;
a cavitation unit downstream of the separation unit, wherein the cavitation unit receives at least a portion of the liquid phase of the hydrotreated heavy oil and subjects the portion of the liquid phase to cavitation to convert at least a portion of the hydrocarbon molecules present in the portion of the liquid phase into lower molecular weight hydrocarbons.

18. The system of claim 17, wherein the cavitation unit is a hydrodynamic cavitation unit.

19. The system of claim 17, wherein the separation unit is a single stage flash vessel.

20. The system of claim 17, further comprising the stream of hydrotreated heavy oil, and wherein the hydrotreated heavy oil has a T95 of 900° F. or higher.

21. The system of claim 17, further comprising a hydrotreater.

22. The system of claim 21, wherein the system is devoid of a heat exchanger between the hydrotreater and the separation unit.
